(19) United States
(12) Patent Application Publication
(10) Pub. No.: US 2024/0425067 A1
(43) Pub. Date: Dec. 26, 2024

(54) OPTIMAL CALCULATION APPARATUS

(71) Applicant: Mitsubishi Electric Corporation, Tokyo (JP)

(72) Inventors: Yu TAKEUCHI, Tokyo (JP); Noriyoshi YAMASHINA, Tokyo (JP); Toshihiko HASHIBA, Tokyo (JP); Saori WADA, Tokyo (JP); Junya HATTORI, Tokyo (JP)

(73) Assignee: Mitsubishi Electric Corporation, Tokyo (JP)

(21) Appl. No.: 18/698,780

(22) PCT Filed: Nov. 19, 2021
(86) PCT No.: PCT/JP2021/042531

§ 371 Date: Apr. 5, 2024

(51) Int. Cl. B60W 50/06; G06F 9/448

(52) U.S. Cl. CPC B60W 50/06; G06F 9/4494; B60W 2710/205; B60W 2710/207; B60W 2720/106

(57) ABSTRACT

To provide an optimal calculation apparatus which can reduce the calculation using the evaluation elements, such as constraint condition, in the initial calculation using the initial value when solving the optimization problem. An optimal calculation apparatus sets an initial value of an input variable of a specific type by switching a plurality of setting methods so that an evaluation element of an object type relevant to the input variable of the specific type can be excluded from the optimization problem in an initial calculation using the initial value; and in the initial calculation using the initial value, excludes the evaluation element of the object type relevant to the input variable of the specific type from the optimization problem, and performs calculation for solving the optimization problem.

### TECHNICAL FIELD

The present disclosure relates to an optimal calculation apparatus.

### BACKGROUND ART

In the technology of patent document 1, the initial value and the prediction period when solving the optimal control problem are set according to the change of the state of the ego vehicle, and the change of the periphery state.

### CITATION LIST

### Patent Literature

Patent document 1: JP 2020-8889 A

### SUMMARY OF INVENTION

### Technical Problem

However, in the technology of patent document 1, when the change is large, the initial value is set using a random number, so in the initial calculation using the initial value when solving the optimization problem, the state variable may be constrained by the constraint condition which is the evaluation element. If the state variable is constrained by the constraint condition in the initial calculation, the computation load increases.

Then, the purpose of the present disclosure is to provide an optimal calculation apparatus which can reduce the calculation using the evaluation elements, such as the constraint condition, in the initial calculation using the initial value when solving the optimization problem.

### Solution to Problem

An optimal calculation apparatus according to the present disclosure, including:
an initial value setting unit that sets an initial value of an input variable at each time point of a prediction period; and
an optimum value calculation unit that, every calculation cycle, updates the input variable from the initial value by repeated calculations, so as to solve an optimization problem with two or more evaluation elements, using a state equation which calculates a state variable with the input variable as an input; and calculates optimum values of the state variable and the input variable at each time point of the prediction period,
wherein the initial value setting unit sets the initial value of the input variable of a specific type by switching a plurality of setting methods so that the evaluation element of an object type relevant to the input variable of the specific type can be excluded from the optimization problem in an initial calculation using the initial value in the optimum value calculation unit, and
wherein, in the initial calculation using the initial value, the optimum value calculation unit excludes the evaluation element of the object type relevant to the input variable of the specific type from the optimization problem, and calculates the optimum values.

### Advantage of Invention

According to the optimal calculation apparatus of the present disclosure, since the initial value of the input variable of the specific type is set by switching the plurality of setting methods so that the evaluation element of the object type relevant to the input variable of the specific type can be excluded, the initial calculation using the initial value can be performed while excluding the evaluation element of the object type from the optimization problem, and the arithmetic processing load can be reduced.

### BRIEF DESCRIPTION OF THE DRAWINGS

FIG. 1 is a schematic block diagram of the vehicle control apparatus and the vehicle system in which the optimal calculation apparatus is embedded, according to Embodiment 1;

FIG. 2 is a hardware configuration diagram of the vehicle control apparatus, according to Embodiment 1;

FIG. 3 is a hardware configuration figure of the another example of the vehicle control apparatus, according to Embodiment 1;

FIG. 4 is a figure for explaining the coordinate system of the ego vehicle, according to Embodiment 1;

FIG. 5 is a figure for explaining the setting of the constraint condition of the acceleration, and the initial value of jerk, according to Embodiment 1;

FIG. 6 is a flowchart for explaining the setting of the initial value of jerk, according to Embodiment 1;

FIG. 7 is a figure for explaining the setting of the constraint condition of the acceleration, and the initial value of jerk, according to Embodiment 2;

FIG. 8 is a flowchart for explaining the setting of the initial value of jerk, according to Embodiment 2; and

FIG. 9 is a flowchart for explaining the setting of the initial value of jerk, according to Embodiment 3.

### DETAILED DESCRIPTION OF THE EMBODIMENTS

### 1. Embodiment 1

An optimal calculation apparatus according to Embodiment 1 will be explained with reference to drawings. In the present embodiment, the optimal calculation apparatus is mounted in the ego vehicle, and performs an optimal calculation of a control of the ego vehicle. The optimal calculation apparatus is embedded in a vehicle control apparatus 50. A vehicle system 1 and the vehicle control apparatus 50 are mounted in the ego vehicle.

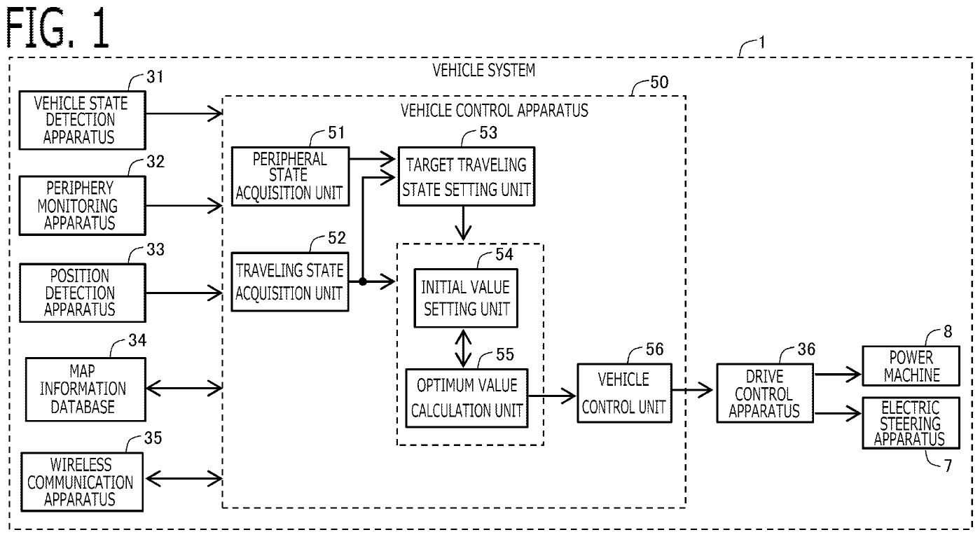

As shown in FIG. 1, the vehicle system 1 is provided with a vehicle state detection apparatus 31, a periphery monitoring apparatus 32, a position detection apparatus 33, a map information database 34, a wireless communication apparatus 35, a vehicle control apparatus 50, a drive control apparatus 36, a power machine 8, an electric steering apparatus 7, and the like.

The vehicle state detection apparatus 31 is a detection apparatus which detects a traveling state of the ego vehicle. As the traveling state of the ego vehicle, a vehicle speed V, an acceleration α, a roll angle speed, a pitch angle speed, and a yaw angle speed γ of the ego vehicle are detected. For example, as the vehicle state detection apparatus 31, a three axes angular velocity sensor which detects the roll angle speed, the pitch angle speed, and the yaw angle speed which are worked on the ego vehicle, an acceleration sensor, and a speed sensor which detects a rotational speed of the wheels are provided. The speed of the ego vehicle may be detected by other methods, such as the integration of the acceleration.

The periphery monitoring apparatus 32 is an apparatus which monitors the periphery of the vehicle, such as a camera and a radar. As the radar, a millimeter wave radar, a laser radar, an ultrasonic radar, and the like are used. The wireless communication apparatus 35 performs a wireless communication with a base station, using the wireless communication standard of cellular communication system, such as 4G and 5G.

The position detecting apparatus 33 is an apparatus which detects the present position (latitude, longitude, altitude) of the ego vehicle, and a GPS antenna which receives the signal outputted from satellites, such as GNSS (Global Navigation Satellite System), is used. For detection of the present position of the ego vehicle, various methods, such as the method using the traveling lane identification number of the ego vehicle, the map matching method, the dead reckoning method, and the method using the detection information around the ego vehicle, may be used.

In the map information database 34, road information, such as a road shape (for example, a road position, a number of lanes, a shape of each lane, a road type, a limit speed, and the like), a sign, and a road signal, is stored. The map information database 34 is mainly constituted of a storage apparatus. The map information database 34 may be provided in a server outside the vehicle connected to the network, and the vehicle control apparatus 50 may acquire required road information from the server outside the vehicle via the wireless communication apparatus 35.

As the drive control apparatus 36, a power controller, a brake controller, an automatic steering controller, a light controller, and the like are provided. The power controller controls output of a power machine 8, such as an internal combustion engine and a motor. The brake controller controls brake operation of an electric brake apparatus. The automatic steering controller controls the electric steering apparatus 7. The light controller controls a direction indicator, a hazard lamp, and the like.

### 1-1. Vehicle Control Apparatus 50

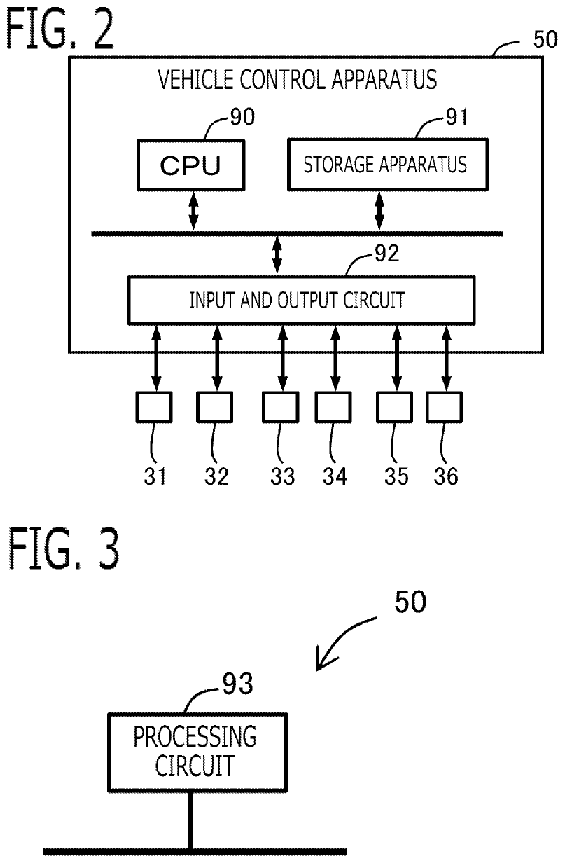

The vehicle control apparatus 50 is provided with functional units such as a peripheral state acquisition unit 51, a traveling state acquisition unit 52, a target traveling state setting unit 53, an initial value setting unit 54, an optimum value calculation unit 55, and a vehicle control unit 56. Each function of the vehicle control apparatus 50 is realized by processing circuits provided in the vehicle control apparatus 50. As shown in FIG. 2, specifically, the vehicle control apparatus 50 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), a hard disk, and a DVD apparatus, are used.

The input and output circuit 92 is provided with a communication device, an A/D converter, an input/output port, a driving circuit, and the like. The input and output circuit 92 is connected to the vehicle state detection apparatus 31, the periphery monitoring apparatus 32, the position detection apparatus 33, the map information database 34, the wireless communication apparatus 35, and the drive control apparatus 36, and communicates with these devices.

Then, the arithmetic processor 90 runs software items (programs) stored in the storage apparatus 91 and collaborates with other hardware devices in the vehicle control apparatus 50, such as the storage apparatus 91, and the input and output circuit 92, so that the respective functions of the functional units 51 to 56 provided in the vehicle control apparatus 50 are realized. Setting data items, such as a determination value to be utilized in the functional units 51 to 56 are stored, as part of software items (programs), in the storage apparatus 91 such as EEPROM.

Alternatively, as shown in FIG. 3, the vehicle control apparatus 50 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the vehicle control apparatus 50 will be described in detail below.

### 1-1-1. Peripheral State Acquisition Unit 51

The peripheral state acquisition unit 51 acquires a peripheral state of the ego vehicle. For example, the peripheral state acquisition unit 51 detects other vehicles and the like which exist around the ego vehicle. The peripheral state acquisition unit 51 detects a position, a traveling direction, a traveling speed, and the like of other vehicle, based on the detection information acquired from the periphery monitoring apparatus 32, and the position information on the ego vehicle acquired from the periphery monitoring apparatus 32. The peripheral state acquisition unit 51 detects a lane shape such as a road lane marking, an obstacle, a pedestrian, a sign, and the like other than other vehicles.

### 1-1-2. Traveling State Acquisition Unit 52

The traveling state acquisition unit 52 acquires a traveling state of the ego vehicle. The traveling state acquisition unit 52 acquires the vehicle speed V, the acceleration α, the roll angle speed, the pitch angle speed, and the yaw angle speed γ of the ego vehicle from the vehicle state detection apparatus 31, as the traveling state of the ego vehicle. The traveling state acquisition unit 52 acquires the position, the traveling direction, and the like of the ego vehicle, based on the position information on the ego vehicle acquired from the position detection apparatus 33. The traveling state acquisition unit 52 acquires the information on the traveling position of the ego vehicle with respect to the lane, based on the shape of lane acquired from the peripheral state acquisition unit 51. The traveling state acquisition unit 52 acquires a driving operation state, such as a steering angle δ, an output of the power machine, such as the internal combustion engine, and an operating state of the brake, from the vehicle control unit 56.

### 1-1-3. Target Traveling State Setting Unit 53

The target traveling state setting unit 53 sets a target traveling state of the ego vehicle. The target traveling state setting unit 53 generates the target traveling state adjusted with the state of other vehicles, the road shape, the obstacle, the pedestrian, and the like around the ego vehicle detected by the peripheral state acquisition unit 51. In the present embodiment, the target traveling state is a target traveling trajectory, and is a time series traveling plan of the position of the ego vehicle, the traveling direction of the ego vehicle, the speed of the ego vehicle, and the like at each future time point. Various well-known methods are used for the generation of the target traveling trajectory.

### 1-1-4. Vehicle Control Unit 56

The vehicle control unit 56 controls the ego vehicle based on a target value of vehicle control amount set by the optimum value calculation unit 55 described below. In the present embodiment, the target value of vehicle control amount is a target value of steering angle δ at each time point, and a target value of acceleration α at each time point.

The vehicle control unit 56 calculates a command value to the power controller, a command value to the brake controller, and a command value to the automatic steering controller, based on the target value of steering angle δ at each time point, and the target value of acceleration α at each time point; and transmits them to each apparatus.

The power controller controls the output of the power machine, such as the internal combustion engine and the motor, according to the command value. The brake controller controls the brake operation of the electric brake apparatus, according to the command value. The automatic steering controller controls the electric steering apparatus, according to the command value.

### 1-1-5. Initial Value Setting Unit 54 and Optimum Value Calculation Unit 55

The initial value setting unit 54 sets an initial value u0(k) of an input variable u(k) at each time point k of a prediction period. The optimum value calculation unit 55 updates the input variable u from the initial value u0 by repeated calculations, so as to solve an optimization problem with two or more evaluation elements, using a state equation which calculates a state variable x with the input variable u as an input; and calculates an optimum value u*(k) of the input variable at each time point k of the prediction period, every calculation cycle.

### State Equation of State Variable

As shown in the next equation, the state equation of the state variable x is expressed by a function f which receives the state variable x(k) and the input variable u(k) at each time point k, and calculates a time differential dx/dt(k) of the state variable at each time point k. If the state variable is plural, x becomes a vector. If the input variable is plural, u becomes a vector. Herein, k expresses each time point in the prediction period. k=0 is present, and k=N is the end point in the prediction period and is called a horizon.

$$\begin{matrix}[ Math . 1 ] & \\ \begin{matrix}\dot{x} ( k ) = f ( x ( k ) , u ( k ) ) \\ k = 0 , 1 , …… , N - 1 , N\end{matrix} & ( 1 )\end{matrix}$$

As shown in the next equation, the state variable x(k+1) at the next time point is calculated by adding a value obtained by multiplying a time interval ΔT between the time points in the prediction period to the time differential dx(k)/dt of the state variable at the present time point, to the state variable x(k) at the present time point.

$$\begin{matrix}[ Math . 2 ] & \\ x ( k + 1 ) = x ( k ) + \dot{x} ( k ) \times Δ T & ( 2 )\end{matrix}$$

The state variable x(0) of k=0 is set to the detected present state variable. The input variable u(k) at each time point k in the prediction period (k=0, . . . , N) becomes the initial value, or the updated value of the previous repeated calculation. While the time point k is increased one by one from 0 to N, the state variable x (k+1) at the next time point k+1 is calculated in order, using the equation (1) and the equation (2), based on the input variable u(k) and the state variable x(k) at present time point k.

### Optimization Problem

A general optimization problem like the next equation is considered.

$$\begin{matrix}[ Math . 3 ] & \\ \begin{matrix}Minimize J ( x ( k ) , u ( k ) ) \\ subject to {g}_{i} ( x ( k ) , u ( k ) ) \leq 0 \\ k = 0 , … , N \\ i = 1 , … , 0\end{matrix} & ( 3 )\end{matrix}$$

Herein, J is an evaluation function which evaluates the state variable x(k) and the input variable u(k), and is a first evaluation element. In the present embodiment, the evaluation function J is a quadratic equation. g is a constraint condition which constrains the state variable x(k) and the input variable u(k), and there are the constraint conditions of set number O. The constraint conditions of the set number O are the second and subsequent evaluation elements.

The general optimization problem of the equation (3) may be solved as it is. But, in the present embodiment, as shown in the next equation, the optimization problem has Karush-Kuhn-Tucker condition which is an optimal condition, to be satisfied by the optimum values, which linearly combines gradients of two or more the evaluation elements by Lagrange multipliers λ.

$$\begin{matrix}[ Math . 4 ] & \\ ∇ J ( {x}^{*} ( k ) , {u}^{*} ( k ) ) + {\sum }_{i = 1}^{M} {λ}_{i} ∇ {g}_{i} ( {x}^{*} ( k ) , {u}^{*} ( k ) ) = 0 & ( 4 )\end{matrix}$$

$${g}_{i} ( {x}^{*} ( k ) , {u}^{*} ( k ) ) \leq 0 \qquad ( 5 )$$

$${λ}_{i} ∇ {g}_{i} ( {x}^{*} ( k ) , {u}^{*} ( k ) ) = 0 \qquad ( 6 )$$

$$\begin{matrix}{λ}_{i} \geq 0 \\ k = 0 , … , N \\ i = 1 , … , O\end{matrix} \qquad ( 7 )$$

Herein, nabla is an operator which performs partial differential at an operating point and calculates a gradient. x* is an optimum value of the state variable, and u* is an optimum value of the input variable. λi is a Lagrange multiplier which linearly combines the gradient of each constraint condition gi to the gradient of the evaluation function J. If the state variable x and the input variable u are the optimum values, a value of each Lagrange multiplier λi which satisfies all the equations of the equation (4) to the equation (7) exists. Well-known methods, such as the active-set method which calculates the optimum values which satisfy KKT condition, are used.

### Problem of Reduction of Arithmetic Processing Load

In the active-set method, the state variable x* and the input variable u* with which the equation (4) to the equation (6) are satisfied are repeatedly generated, the generation is ended when the equation (7) is satisfied, and the state variable x* and the input variable u* when the equation (7) is satisfied are calculated as the final optimum values.

Specifically, after generating the state variable x* and the input variable u* with which the equation (4) to the equation (6) are satisfied, the constraint condition g whose Lagrange multiplier λ becomes negative does not constrain the optimum value, and is determined as the inactive constraint condition g. After setting the Lagrange multiplier λ of its inactive constraint condition g to 0 and excluding its inactive constraint condition g from the KKT condition, the state variable x* and the input variable u* with which the equation (4) to the equation (6) are satisfied are generated again. This generation of the state variable x* and the input variable u* are repeatedly executed until there are no more Lagrange multipliers λ which become negative. The exclusion of the constraint condition g is performed one by one.

As a difference between the number of active constraint conditions g initially set and the number of active constraint conditions g finally remained becomes smaller, the number of calculations of the optimum values can be reduced and the arithmetic processing load can be reduced. Accordingly, it is desirable to reduce the number of initial active constraint conditions g as much as possible. However, unless the setting of the initial value u0(k) of the input variable is devised, the number of active constraint conditions g initially set cannot be reduced.

### Setting of Initial Value for Reducing Computation Load

Then, the initial value setting unit 54 sets the initial value of the input variable of a specific type by switching a plurality of setting methods so that the evaluation element of an object type relevant to the input variable of the specific type (in this example, constraint condition) can be excluded from the optimization problem in the initial calculation using the initial value u0 of the input variable in the optimum value calculation unit 55.

Then, in the initial calculation using the initial value, the optimum value calculation unit 55 excludes the evaluation element of the object type relevant to the input variable of the specific type (in this example, constraint condition) from the optimization problem, and calculates the optimum values.

According to this configuration, since the initial value of the input variable of the specific type is set by switching the plurality of setting methods so that the constraint condition of the object type relevant to the input variable of the specific type can be excluded, the initial calculation using the initial value can be performed while excluding the constraint condition of the object type from the optimization problem, and the arithmetic processing load can be reduced.

If the KKT condition and the active-set method are used, the Lagrange multiplier λ of the constraint condition of the object type is set to 0 in the initial calculation using the initial value, and the number of the active constraint conditions initially set can be reduced, and the arithmetic processing load can be reduced. Even when the general optimization problem of the equation (3) is solved, the initial calculation using the initial value cannot be constrained by the constraint condition of the object type, so the arithmetic load can be reduced.

### Vehicle Model

In the present embodiment, as the state equation, a state equation of a vehicle model which receives the input variable u related to vehicle control, and calculate the state variable x expressing the behavior of the ego vehicle is used. A two-wheel model is used for the vehicle model. As shown in the next equation, the state equation of the vehicle model can be expressed by a differential equation of each state variable expressing the behavior of the ego vehicle. As the state equation of the vehicle model, various well-known state equations may be used.

$$\begin{matrix}[ Math . 5 ] & \\ \dot{x} ( k ) = [ \begin{matrix}\dot{Y} ( k ) \\ \dot{X} ( k ) \\ \dot{θ} ( k ) \\ \dot{β} ( k ) \\ \dot{γ} ( k ) \\ \dot{δ} ( k ) \\ \dot{V} ( k ) \\ \dot{α} ( k )\end{matrix} ] = [ \begin{matrix}V ( k ) cos ( θ ( k ) + β ( k ) ) \\ V ( k ) sin ( θ ( k ) + β ( k ) ) \\ γ ( k ) \\ - γ ( k ) + \frac{2 ( {Y}_{f} ( k ) + {Y}_{r} ( k ) )}{M \cdot V ( k )} \\ \frac{2}{I} ( {L}_{f} {Y}_{f} ( k ) - {L}_{r} {Y}_{r} ( k ) ) \\ ω ( k ) \\ α ( k ) \\ j ( k )\end{matrix} ] & ( 8 )\end{matrix}$$

$${Y}_{f} ( k ) = - {C}_{f} ( β ( k ) + \frac{{L}_{f}}{V ( k )} γ ( k ) - δ ( k ) )$$

$${Y}_{r} ( k ) = - {C}_{r} ( β ( k ) - \frac{{L}_{r}}{V ( k )} γ ( k ) )$$

$$u ( k ) = {[ j ( k ) , ω ( k ) ]}^{T}$$

Herein, a dot sign of the upper part of each variable on the left side indicates a time differential value of each state variable. As the state variable x, Y is a position in the longitudinal direction of the ego vehicle; X is a position in the lateral direction of the ego vehicle; θ is a slope in the longitudinal direction of the ego vehicle; β is a lateral slip angle of a center of gravity of the ego vehicle; γ is a yaw angle speed of the ego vehicle; δ is a steering angle of wheel of the ego vehicle; V is a speed of the ego vehicle; and α is an acceleration of the ego vehicle.

As the input variable u, j is a jerk of the ego vehicle, and ω is a steering angle speed of the ego vehicle.

I is a yaw inertia moment of vehicle; M is a mass of vehicle; Lf is a distance between the vehicle center of gravity and an axle of the front wheel; and Lr is a distance between the vehicle center of gravity and an axle of the rear wheel. Yf is a cornering force of the front wheel; Yr is a cornering force of the rear wheel; Cf is a cornering stiffness of the front wheel tire; and Cr is a cornering stiffness of the rear wheel tire.

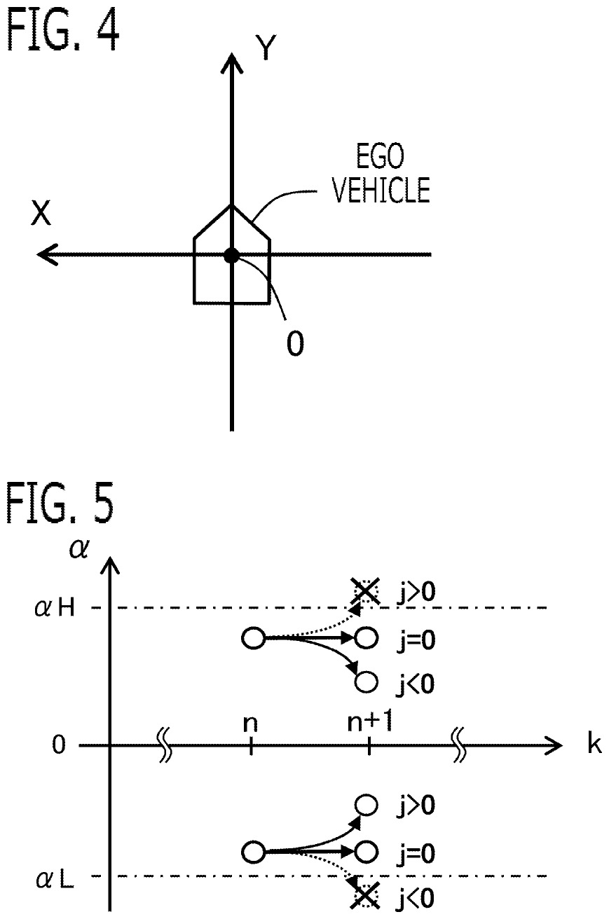

The state equation is expressed in an ego vehicle coordinate system X, Y on the basis of the present position of the ego vehicle. As shown in FIG. 4, X is the lateral direction of the ego vehicle, and Y is the longitudinal direction of the ego vehicle. Instead of the ego vehicle coordinate system, a coordinate system on the basis of the target traveling trajectory may be used.

### Evaluation Function

In the present embodiment, the next equation of the quadratic equation is used as the evaluation function J which evaluates the desirability of the vehicle behavior. The evaluation function J is the evaluation element whose evaluation becomes higher (in this example, a value becomes smaller), as a difference between the target traveling state (target traveling trajectory) and the prediction traveling state becomes smaller. The evaluation function J may be modified from the equation (9).

$$\begin{matrix}[ Math . 6 ] & \\ J = {( y ( N ) - {y}_{r e f} ( N ) )}^{T} P ( y ( N ) - {y}_{r e f} ( N ) ) + {\sum }_{k = 1}^{N - 1} ( {( y ( k ) - {y}_{r e f} ( k ) )}^{T} Q ( y ( k ) - {y}_{r e f} ( k ) ) + {u ( k )}^{T} R u ( k ) ) & ( 9 )\end{matrix}$$

$$y ( k ) = {[ Y ( k ) , X ( k ) , θ ( k ) , V ( k ) ]}^{T}$$

$${y}_{r e f} ( k ) = {[ {Y}_{r e f} ( k ) , {X}_{r e f} ( k ) , {θ}_{r e f} ( k ) , {V}_{r e f} ( k ) ]}^{T}$$

Herein, k(k=0, 1, . . . , N−1, N) is a time point number expressing each time point in the prediction period. k=0 is present and k=N expresses the final prediction time point. The time point number k is increased one by one from 0 to N at every time interval ΔT. Accordingly, k×ΔT is an elapsed time of each time point k from present. y(k) is a vector of the output variables of the state equation at each time point k. yref(k) is a vector of the target values of output variables at each time point k, and values of the target traveling trajectory at each time point k is set. P is a weight to a deviation from the target value of output variable at the final prediction time point (k=N). Q is a weight to a deviation from the target value of output variable at future each time point (k=1, . . . , N−1) except the final prediction time point. A deviation of the traveling state of the vehicle from the target traveling trajectory at each time point is evaluated by the terms of these weights P and Q. R is a weight to a deviation from the target value of input variable at future each time point (k=1, . . . , N−1) except the final prediction time point. By the term of this weight R, the jerk j and the steering angle speed ω of the ego vehicle are evaluated so as not to become large too much. Accordingly, variation of the steering angle and variation of the vehicle acceleration, and a following property to the target traveling trajectory are balanced by setting of each weight P, Q, and R, and vehicle control with few uncomfortable feelings for the driver is performed.

The target value of vehicle control amount at each time point k is set to the steering angle δ*(k) and the acceleration α*(k) included in the optimum value x*(k) of the state variable at each time point k after the optimization problem was solved.

### Constraint Condition

In the present embodiment, as shown in the next equation, as the first and the second constraint conditions g1, g2, the acceleration α is upper-limited by a positive upper limit value αH, and is lower-limited by a negative lower limit value αL. This is for improving riding comfort.

$$\begin{matrix}[ Math . 7 ] & \\ \begin{matrix}\begin{matrix}{g}_{1} : & α ( k ) - α H \leq 0\end{matrix} \\ \begin{matrix}{g}_{2} : & - α ( k ) + α L \leq 0\end{matrix} \\ α H > 0 , α L < 0\end{matrix} & ( 10 )\end{matrix}$$

And, as shown in the next equation, as the third and the fourth constraint conditions g3, g4, the position X in the lateral direction is upper-limited by a positive upper limit value XH, and is lower-limited by a negative lower limit value XL. This is for preventing deviation from a planned traveling range. When the target traveling trajectory is curved, the upper limit value XH and the lower limit value XL at each time point may be changed according to the target traveling trajectory at each time point.

$$\begin{matrix}[ Math . 8 ] & \\ \begin{matrix}\begin{matrix}{g}_{3} : & X ( k ) - XH \leq 0\end{matrix} \\ \begin{matrix}{g}_{4} : & - X ( k ) + XL \leq 0\end{matrix} \\ XH > 0 , X L < 0\end{matrix} & ( 11 )\end{matrix}$$

### Setting of Initial Value of Jerk

As mentioned above, the initial value setting unit 54 sets the initial value of the input variable of the specific type by switching the plurality of setting methods so that the evaluation element of the object type relevant to the input variable of the specific type can be excluded from the optimization problem in the initial calculation using the initial value u0 of the input variable in the optimum value calculation unit 55.

In the present embodiment, the input variable of the first specific type is set to the jerk j, and the evaluation element of the first object type relevant to the input variable of the first specific type is set to the first and the second constraint conditions g1, g2 shown in the equation (10).

Then, the initial value setting unit 54 sets the initial value j0 of jerk by switching the plurality of setting methods so that the first and the second constraint conditions g1, g2 relevant to the jerk j can be excluded from the optimization problem in the initial calculation using the initial value j0 of jerk.

Specifically, in the initial calculation using the initial value j0(k) of jerk in the optimum value calculation unit 55, using the next equation derived from the equation (8) and the equation (2), the acceleration α(k) at each time point is calculated in order from k=0 to k=N, based on the set initial value j0(k) of jerk at each time point. The initial value setting unit 54 sets the initial value j0(k) of jerk at each time point so that the acceleration α(k) at each time point is not upper-limited by the positive upper limit value αH, and is not lower-limited by the negative lower limit value αL. Herein, α(0) is set to the present detection value.

$$\begin{matrix}[ Math . 9 ] & \\ α ( k + 1 ) = α ( k ) + {j}_{0} ( k ) \times Δ T & ( 12 )\end{matrix}$$

If the initial value j0(k) of jerk is set in this way, as mentioned above, in the initial calculation using the initial value u0, the optimum value calculation unit 55 sets the Lagrange multipliers λ1 and λ2 of first and the second constraint conditions g1, g2 to 0, and the number of the active constraint conditions initially set can be reduced. Accordingly, the arithmetic processing load of the optimum value calculation unit 55 can be reduced.

### Setting of Initial Value of Jerk by Two Positives or Negatives

As shown in the equation (10), the first and the second constraint conditions g1, g2 (evaluation elements of the object type) are the evaluation elements for upper-limiting and lower-limiting the acceleration α (state variable of the specific influence) which is the state variable changing according to the jerk j (input variable of the specific type) by the positive upper limit value αH and the negative lower limit value αL.

In the present embodiment, the initial value setting unit 54 determines whether or not a positive or negative of the optimum value j* of jerk calculated in the previous calculation cycle and a positive or negative of the optimum value α* of acceleration calculated in the previous calculation cycle coincide with each other; and sets the initial value j0 of jerk by switching the plurality of setting methods according to whether or not two positives or negatives coincide.

As shown in the image of FIG. 5, when the jerk j(k) is positive in the state where the acceleration α(k) at the certain time point k is positive, the acceleration α(k+1) at the next time point k+1 approaches the upper limit value αH, and may be constrained by the first constraint condition g1. Similarly, when the jerk j(k) is negative in the state where the acceleration α(k) at the certain time point k is negative, the acceleration α(k+1) at the next time point k+1 approaches the lower limit value αL, and may be constrained by the second constraint condition g2.

Accordingly, by setting the initial value j0 of jerk by switching the setting methods according to whether or not two positives or negatives coincide, the initial value can be set so that the acceleration α does not go beyond the upper limit value αH or the lower limit value αL.

In the present embodiment, when two positives or negatives do not coincide, the initial value setting unit 54 uses the setting method which sets the initial value j0 of jerk to the optimum value j* of jerk calculated in the previous calculation cycle.

According to this configuration, when two positives or negatives do not coincide, even if the initial value is set to the optimum value of the previous calculation cycle, the possibility that the acceleration α approaches the upper limit value H or the lower limit value αL can be reduced. Since the optimum value of the present calculation cycle is estimated to be close to the optimum value of the previous calculation cycle, the arithmetic processing load of the search for the optimum value can be reduced by setting the initial value to the optimum value of the previous calculation cycle.

On the other hand, when two positives or negatives coincide, the initial value setting unit 54 uses the setting method which sets the initial value j0 of jerk to a switching value such that the acceleration α does not go beyond the upper limit value αH or the lower limit value αL.

According to this configuration, when two positives or negatives coincide, by setting the initial value j0 of jerk to the switching value such that the acceleration α does not go beyond the upper limit value αH or the lower limit value αL, the acceleration α can be prevented from going beyond the upper limit value αH or the lower limit value αL.

In the present embodiment, the initial value setting unit 54 uses 0 as the switching value.

According to this configuration, when two positives or negatives coincide, since the initial value j0 of jerk is set to 0, the acceleration α does not increase or decrease and is maintained at constant value. Accordingly, the acceleration α is suppressed from approaching the upper limit value αH or the lower limit value αL, and the acceleration α can be prevented from going beyond the upper limit value αH or lower limit value αL.

A value other than 0 may be used as the switching value. The initial value setting unit 54 may set the switching value based on a value according to the upper limit value αH or the lower limit value αL. For example, the initial value setting unit 54 may set, as the switching value, a value obtained by multiplying a coefficient which is set according to a deviation (a margin) between the acceleration α and either the upper limit value αH or the lower limit value αL on the approaching side, to the optimum value of the previous calculation cycle. As the deviation (margin) becomes smaller, the coefficient is made smaller than 1. When the deviation (margin) is 0, the coefficient is set to 0.

The initial value setting unit 54 performs the above setting for the initial value j0(k) of jerk at each time point k.

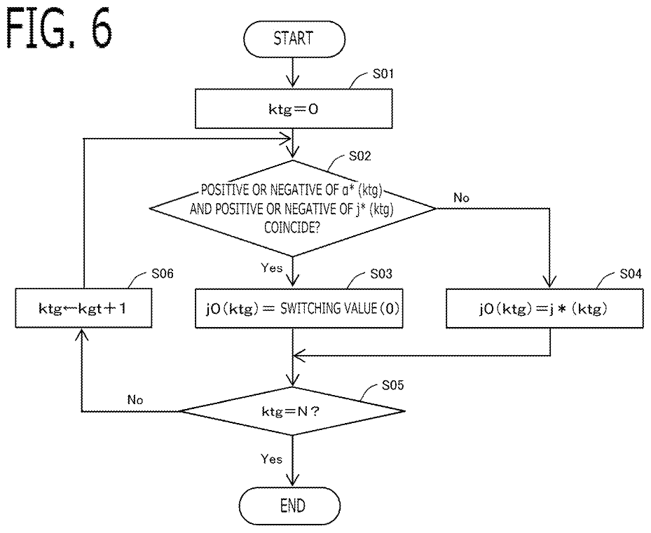

The processing of the initial value setting unit 54 explained above can be configured like the flowchart of FIG. 6. In the step S01, the time point ktg of processing object is set to 0. Then, in the step S02, the initial value setting unit 54 determines whether or not a positive or negative of the optimum value α*(ktg) of acceleration at the time point ktg of processing object calculated in the previous calculation cycle, and a positive or negative of optimum value j*(ktg) of jerk at the time point ktg of processing object calculated in the previous calculation cycle coincide with each other. When two positives or negatives coincide, it advances to the step S03, and when two positives or negatives do not coincide, it advances to the step S04.

In the step S03, the initial value setting unit 54 sets the initial value j0(ktg) of jerk at the time point ktg of processing object, to the switching value such that the acceleration α does not go beyond the upper limit value αH or the lower limit value αL (in this example, 0). On the other hand, in the step S04, the initial value setting unit 54 sets the initial value j0(ktg) of jerk at the time point ktg of processing object, to the optimum value j*(ktg) of jerk at the time point ktg of processing object calculated in the previous calculation cycle.

Then, in the step S05, the initial value setting unit 54 determines whether or not the time point ktg of processing object is the final time point N. When it is not the final time point N, it advances to the step S06, and the time point ktg of processing object is increased by one, then, it returns to the step S02. When it is the final time point N, the processing is ended.

### Setting of Initial Value of Steering Angle Speed

The input variable of the second specific type is set to the steering angle speed ω, and the evaluation element of the second object type relevant to the input variable of the second specific type is set to the third and the fourth constraint conditions g3, g4 which were shown in the equation (11).

Then, the initial value setting unit 54 sets up the initial value ω0 of steering angle speed by switching the plurality of setting methods so that the third and the fourth constraint conditions g3, g4 relevant to the steering angle speed ω can be excluded from the optimization problem in the initial calculation using the initial value ω0 of steering angle speed.

Specifically, in the initial calculation using the initial value ω0(k) of steering angle speed in the optimum value calculation unit 55, the position X(k) in the lateral direction at each time point is calculated in order from k=0 to k=N, using the equation (8) and the equation (2), based on the set initial value ω0(k) of steering angle speed at each time point. The present detection value is used for the position X(0) in the lateral direction at k=0, and other state variables. The optimum value of the previous calculation cycle or a value set so as to satisfy the constraint conditions is used for the initial value of other input variable at each time point (in this example, initial value j0 of jerk). The initial value setting unit 54 sets the initial value ω0(k) of steering angle speed at each time point so that the position X(k) in the lateral direction at each time point is not upper-limited by the positive upper limit value XH, and is not lower-limited by the negative lower limit value XL.

If the initial value ω0(k) of steering angle speed is set in this way, as mentioned above, in the initial calculation using the initial value ω0, the optimum value calculation unit 55 sets the Lagrange multipliers λ3 and λ4 of the third and the fourth constraint conditions g3, g4 to 0, and the number of the active constraint conditions initially set can be reduced. Accordingly, the arithmetic processing load of the optimum value calculation unit 55 can be reduced.

### Setting of Initial Value of Steering Angle Speed by Two Positives or Negatives

When the steering angle speed ω is positive, the steering angle δ increases, the traveling direction of vehicle changes to the left side, and the position X in the lateral direction changes to the positive direction (the left side). On the other hand, when the steering angle speed ω is negative, the steering angle δ decreases, the traveling direction of vehicle changes to the right side, and the position X in the lateral direction changes to the negative direction (the right side).

As shown in the equation (11), the third and the fourth constraint conditions g3, g4 (the evaluation elements of the object type) are the evaluation elements for upper-limiting and lower-limiting the position X in the lateral direction (the state variable of the specific influence) which is the state variable changing according to the steering angle speed ω (the input variable of the specific type) by the positive upper limit value XH and the negative lower limit value XL.

In the present embodiment, the initial value setting unit 54 determines whether or not a positive or negative of the optimum value ω* of steering angle speed calculated in the previous calculation cycle and a positive or negative of the optimum value X* of position in the lateral direction calculated in the previous calculation cycle coincide with each other; sets the initial value ω0 of steering angle speed by switching the plurality of setting methods according to whether or not two positives or negatives coincide.

Similarly to FIG. 5, when the steering angle speed ω(k) is positive in the state where the position X(k) in the lateral direction at the certain time point k is positive, the position X (k+1) in the lateral direction at the next time point k+1 approaches the upper limit value XH, and may be constrained by the third constraint condition g3. Similarly, when the steering angle speed ω(k) is negative in the state where the position X(k) in the lateral direction at the certain time point k is negative, the position X (k+1) in the lateral direction at the next time point k+1 approaches the lower limit value XL, and may be constrained by the fourth constraint condition g4.

Accordingly, by setting the initial value by switching the setting methods according to whether or not two positives or negatives coincide, the initial value can be set effectively.

In the present embodiment, when two positives or negatives do not coincide, the initial value setting unit 54 uses the setting method which sets the initial value ω0 of steering angle speed to the optimum value ω* of steering angle speed calculated in the previous calculation cycle.

According to this configuration, when two positives or negatives do not coincide, even if the initial value is set to the optimum value of the previous calculation cycle, the possibility that the position X in the lateral direction approaches the upper limit value XH or the lower limit value XL can be reduced. Since the optimum value of the present calculation cycle is estimated to be close to the optimum value of the previous calculation cycle, the arithmetic processing load of the search for the optimum value can be reduced by setting the initial value to the optimum value of the previous calculation cycle.

On the other hand, when two positives or negatives coincide, the initial value setting unit 54 uses the setting method which sets the initial value ω0 of steering angle speed to a switching value such that the position X in the lateral direction does not go beyond the upper limit value XH or the lower limit value XL.

According to this configuration, when two positives or negatives coincide, by setting the initial value ω0 of steering angle speed to the switching value such that the position X in the lateral direction does not go beyond the upper limit value XH or the lower limit value XL, the position X in the lateral direction can be prevented from going beyond the upper limit value XH or the lower limit value XL.

In the present embodiment, the initial value setting unit 54 uses 0 as the switching value.

According to this configuration, when two positives or negatives coincide, since the initial value ω0 of steering angle speed is set to 0, the position X in the lateral direction does not increase or decrease largely. Accordingly, the position X in the lateral direction can be suppressed from approaching the upper limit value XH or the lower limit value XL, and the position X in the lateral direction can be prevented from going beyond the upper limit value XH or the lower limit value XL.

A value other than 0 may be used as the switching value. The initial value setting unit 54 may set the switching value based on a value according to the upper limit value XH or the lower limit value XL. For example, the initial value setting unit 54 may set, as the switching value, a value obtained by multiplying a coefficient which is set according to a deviation (a margin) between the position X in the lateral direction and either the upper limit value XH or the lower limit value XL on the approaching side, to the optimum value of the previous calculation cycle. As the deviation (margin) becomes smaller, the coefficient is made smaller than 1. When the deviation (margin) is 0, the coefficient is set to 0.

The initial value setting unit 54 performs the above setting for the initial value ω0 (k) of steering angle speed at each time point k. Since the setting processing of the initial value ω0 of steering angle speed is similar to the initial value j0 of jerk shown in the flowchart of FIG. 6, explanation is omitted.

### 2. Embodiment 2

Next, the optimal calculation apparatus according to Embodiment 2 will be explained. The explanation for constituent parts the same as those in Embodiment 1 will be omitted. The basic configuration of the optimal calculation apparatus according to the present embodiment is the same as that of Embodiment 1. Embodiment 2 is different from Embodiment 1 in the processing of the initial value setting unit 54.

Also in the present embodiment, the initial value setting unit 54 sets the initial value of the input variable of the specific type by switching the plurality of setting methods so that the evaluation element of the object type relevant to the input variable of the specific type can be excluded from the optimization problem in the initial calculation using the initial value u0 of the input variable in the optimum value calculation unit 55.

### Setting of Initial Value of Jerk

Also in the present embodiment, the input variable of the first specific type is set to the jerk j, and the evaluation element of the first object type relevant to the input variable of the first specific type is set to the first and the second constraint conditions g1, g2 shown in the equation (10). The first and the second constraint conditions g1, g2 (evaluation elements of the object type) are the evaluation elements for upper-limiting and lower-limiting the acceleration α (state variable of the specific influence) which is the state variable changing according to the jerk j (input variable of the specific type) by the positive upper limit value αH and the negative lower limit value αL.

In the present embodiment, the initial value setting unit 54 determines whether or not the acceleration α goes beyond the upper limit value all or the lower limit value αL if the initial value j0 of jerk is set to the optimum value j* of jerk calculated in the previous calculation cycle; sets the initial value j0 of jerk by switching the plurality of setting methods according to whether or not the acceleration α goes beyond.

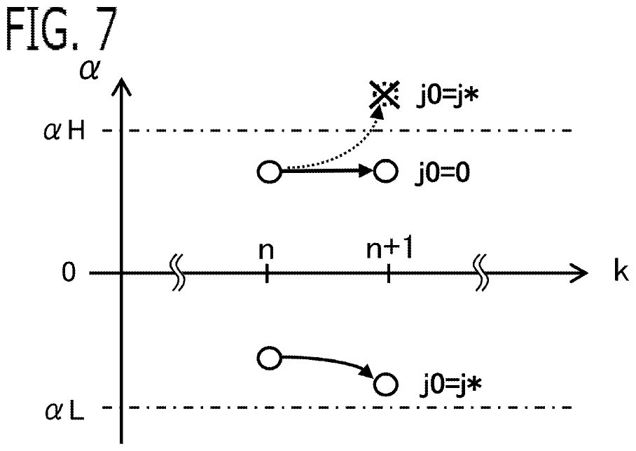

As shown in the image of FIG. 7, when the initial value j0 of jerk is set to the optimum value j* of jerk of the previous calculation cycle, and the acceleration α goes beyond the upper limit value αH or the lower limit value αL, the initial value can be set so that the acceleration α does not go beyond the upper limit value αH or the lower limit value αL, by setting the initial value j0 of jerk by switching the setting methods.

In the present embodiment, when determining that the acceleration α does not go beyond the upper limit value H or the lower limit value αL, the initial value setting unit 54 uses the setting method which sets the initial value j0 of jerk to the optimum value j* of jerk calculated in the previous calculation cycle.

According to this configuration, when determining that it does not go beyond, the arithmetic processing load of the search for the optimum value can be reduced by setting the initial value to the optimum value of the previous calculation cycle.

On the other hand, when determining that the acceleration α goes beyond the upper limit value αH or the lower limit value αL, the initial value setting unit 54 uses the setting method which sets the initial value j0 of jerk to a switching value such that the acceleration α does not go beyond the upper limit value αH or the lower limit value αL.

According to this configuration, when determining that it goes beyond, by setting the initial value j0 of jerk to the switching value such that the acceleration α does not go beyond the upper limit value αH or the lower limit value αL, the acceleration α can be prevented from going beyond the upper limit value αH or lower limit value αL.

In the present embodiment, the initial value setting unit 54 uses 0 as the switching value.

According to this configuration, when determining that it goes beyond, since the initial value j0 of jerk is set to 0, the acceleration α does not increase or decrease and is maintained at constant value. Accordingly, the acceleration α can be prevented from going beyond the upper limit value αH or lower limit value αL.

A value other than 0 may be used as the switching value. The initial value setting unit 54 may set the switching value based on a value according to the upper limit value αH or the lower limit value αL. For example, the initial value setting unit 54 may set, as the switching value, a predetermined value which has a positive or negative opposite to the positive or negative of the upper limit value αH or the lower limit value αL which was gone beyond.

A value that is smaller than the upper limit value αH by a predetermined value may be used as the upper limit value αH used for determination. A value that is larger than the lower limit value αL by a predetermined value may be used as the lower limit value αL used for determination. While a margin is given to the acceleration α with respect to the upper limit value al or the lower limit value αL, the initial value j0 of jerk can be set.

While increasing the time point k one by one from 0 to N, at each time point, using the initial value j0 of jerk already set before its time point and the optimum value j* of jerk at its time point of the previous calculation cycle as the initial value, the initial value setting unit 54 calculates the acceleration α to the next time point in order, and determines whether or not the acceleration α at the next time point goes beyond the upper limit value αH or the lower limit value αL. Then, the initial value setting unit 54 sets the initial value j0 of jerk at its time point to the optimum value j* of jerk at its time point of the previous calculation cycle, when determining that it does not go beyond; and sets the initial value j0 of jerk at its time point to the switching value, when determining that it goes beyond.

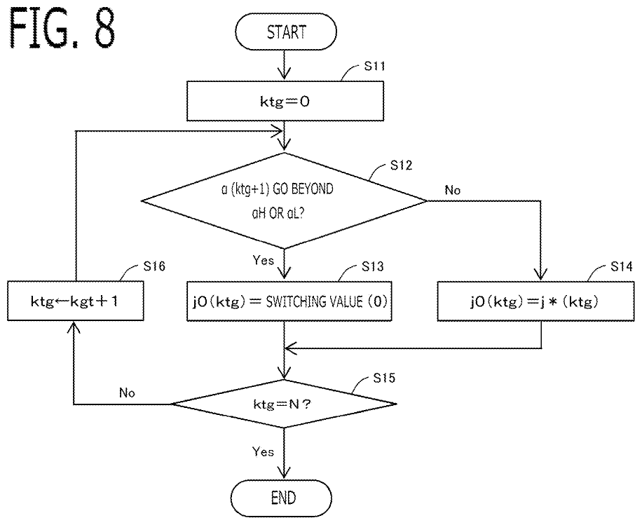

The processing of the initial value setting unit 54 explained above can be configured like the flowchart of FIG. 8. In the step S11, the time point ktg of processing object is set to 0.

In the step S12, using the initial values j0(0) to j0(ktg−1) of jerk already set before the time point ktg of processing object, and the optimum value j*(ktg) of jerk at the time point ktg of processing object of the previous calculation cycle as the initial value j0(ktg) at time point ktg of processing object, and using the equation (12), the initial value setting unit 54 calculates the acceleration α(ktg+1) to the next time point ktg+1 of the processing object in order. Then, the initial value setting unit 54 determines whether the acceleration α(ktg+1) at the next time point of the processing object exceeds the upper limit value αH, or goes below the lower limit value αL. When it exceeds or goes below, it advances to the step S13, and when it does not exceed and does not go below, it advances to the step S14.

In the step S13, the initial value setting unit 54 sets the initial value j0(ktg) of jerk at the time point ktg of processing object, to the switching value (in this example, 0) such that the acceleration α(ktg+1) at the next time point of the processing object does not go beyond the upper limit value αH or the lower limit value αL. On the other hand, in the step S14, the initial value setting unit 54 sets the initial value j0(ktg) of jerk at the time point ktg of processing object, to the optimum value j*(ktg) of jerk at the time point ktg of processing object calculated in the previous calculation cycle.

Then, in the step S15, the initial value setting unit 54 determines whether or not the time point ktg of processing object is the final time point N. When it is not the final time point N, it advances to the step S16, and the time point ktg of processing object is increased by one, then, it returns to the step S12. When it is the final time point N, the processing is ended.

### Setting of Initial Value of Steering Angle Speed

The input variable of the second specific type is set to the steering angle speed ω, and the evaluation element of the second object type relevant to the input variable of the second specific type is set to the third and the fourth constraint conditions g3, g4 which were shown in the equation (11). The third and the fourth constraint conditions g3, g4 (the evaluation elements of the object type) are the evaluation elements for upper-limiting and lower-limiting the position X in the lateral direction (the state variable of the specific influence) which is the state variable changing according to the steering angle speed ω (the input variable of the specific type) by the positive upper limit value XH and the negative lower limit value XL.

In the present embodiment, the initial value setting unit 54 determines whether or not the position X in the lateral direction goes beyond the upper limit value XH or the lower limit value XL if the initial value ω0 of steering angle speed is set to the optimum value ω* of steering angle speed calculated in the previous calculation cycle; sets the initial value ω0 of steering angle speed by switching the plurality of setting methods according to whether or not the position X in the lateral direction goes beyond.

Similarly to FIG. 7, when the position X in the lateral direction goes beyond the upper limit value XH or the lower limit value XL, the initial value can be set so that the position X in the lateral direction does not go beyond the upper limit value XH or the lower limit value XL, by setting the initial value ω0 of steering angle speed by switching the setting methods.

In the present embodiment, when determining that the position X in the lateral direction does not go beyond the upper limit value XH or the lower limit value XL, the initial value setting unit 54 uses the setting method which sets the initial value ω0 of steering angle speed to the optimum value ω* of steering angle speed calculated in the previous calculation cycle.

According to this configuration, when determining that the position X in the lateral direction does not go beyond, the arithmetic processing load of the search for the optimum value can be reduced by setting the initial value to the optimum value of the previous calculation cycle.

On the other hand, when determining that the position X in the lateral direction goes beyond the upper limit value XH or the lower limit value XL, the initial value setting unit 54 uses the setting method which sets the initial value ω0 of steering angle speed to the switching value such that the position X in the lateral direction does not go beyond the upper limit value XH or the lower limit value XL.

According to this configuration, when determining that the position X in the lateral direction goes beyond, by setting the initial value ω0 of steering angle speed to the switching value such that the position X in the lateral direction does not go beyond the upper limit value XH or the lower limit value XL, the position X in the lateral direction can be prevented from going beyond the upper limit value XH or the lower limit value XL.

In the present embodiment, the initial value setting unit 54 uses 0 as the switching value.

According to this configuration, when determining that it goes beyond, since the initial value ω0 of steering angle speed is set to 0, the position X in the lateral direction does not increase or decrease largely. Accordingly, the position X in the lateral direction can be suppressed from going beyond the upper limit value XH or the lower limit value XL.

A value other than 0 may be used as the switching value. The initial value setting unit 54 may set the switching value based on a value according to the upper limit value XH or the lower limit value XL. For example, the initial value setting unit 54 may set, as the switching value, a predetermined value which has a positive or negative opposite to the positive or negative of the upper limit value XH or the lower limit value XL which was gone beyond.

A value that is smaller than the upper limit value XH by a predetermined value may be used as the upper limit value XH used for determination. A value that is larger than the lower limit value XL by a predetermined value may be used as the lower limit value XL used for determination. While a margin is given to the position X in the lateral direction with respect to the upper limit value XH or the lower limit value XL, the initial value ω0 of steering angle speed can be set.

While increasing the time point k one by one from 0 to N, at each time point, using the initial value ω0 of steering angle speed already set before its time point, and the optimum value ω* of steering angle speed at its time point of the previous calculation cycle as the initial value, the initial value setting unit 54 calculates the position X in the lateral direction to the next time point in order. The present detection value is used for the position X(0) in the lateral direction at k=0, and other state variables. The optimum value of the previous calculation cycle, or a value set so as not to go beyond the upper limit value or the lower limit value is used for the initial value of other input variable at each time point (in this example, initial value j0 of jerk).

Then, the initial value setting unit 54 determines whether or not the position X in the lateral direction at the next time point goes beyond the upper limit value XH or the lower limit value XL. The initial value setting unit 54 sets the initial value ω0 of steering angle speed at its time point to the optimum value ω* of steering angle speed at its time point of the previous calculation cycle, when determining that it does not go beyond; and sets the initial value ω0 of steering angle speed at its time point to the switching value, when determining that it goes beyond.

Since the setting processing of the initial value ω0 of steering angle speed is similar to the initial value j0 of jerk shown in the flowchart of FIG. 8, explanation is omitted.

### 3. Embodiment 3

Next, the optimal calculation apparatus according to Embodiment 3 will be explained. The explanation for constituent parts the same as that of Embodiment 1 or 2 will be omitted. The basic configuration of the optimal calculation apparatus according to the present embodiment is the same as that of Embodiment 1 or 2. Embodiment 3 is different from Embodiment 1 or 2 in the processing of the initial value setting unit 54.

Also in the present embodiment, the initial value setting unit 54 sets the initial value of the input variable of the specific type by switching the plurality of setting methods so that the evaluation element of the object type relevant to the input variable of the specific type can be excluded from the optimization problem in the initial calculation using the initial value u0 of the input variable in the optimum value calculation unit 55.

### Setting of Initial Value of Jerk

Also in the present embodiment, the input variable of the first specific type is set to the jerk j, and the evaluation element of the first object type relevant to the input variable of the first specific type is set to the first and the second constraint conditions g1, g2 shown in the equation (10). The first and the second constraint conditions g1, g2 (evaluation elements of the object type) are the evaluation elements for upper-limiting and lower-limiting the acceleration α (state variable of the specific influence) which is the state variable changing according to the jerk j (input variable of the specific type) by the positive upper limit value αH and the negative lower limit value αL.

Similarly to Embodiment 1, the initial value setting unit 54 determines whether or not a positive or negative of the optimum value j* of jerk calculated in the previous calculation cycle and a positive or negative of the optimum value α* of acceleration calculated in the previous calculation cycle coincide with each other.

Similarly to Embodiment 1, when two positives or negatives do not coincide, the initial value setting unit 54 uses the setting method which sets the initial value j0 of jerk to the optimum value j* of jerk calculated in the previous calculation cycle.

On the other hand, unlike Embodiment 1, when two positives or negatives coincide, similarly to Embodiment 2, the initial value setting unit 54 determines whether or not the acceleration α goes beyond the upper limit value αH or the lower limit value αL if the initial value j0 of jerk is set to the optimum value j* of jerk calculated in the previous calculation cycle. Then, when determining that the acceleration α does not go beyond the upper limit value αH or the lower limit value αL, the initial value setting unit 54 uses the setting method which sets the initial value j0 of jerk to the optimum value j* of jerk calculated in the previous calculation cycle. On the other hand, when determining that the acceleration α goes beyond the upper limit value αH or the lower limit value αL, the initial value setting unit 54 uses the setting method which sets the initial value j0 of jerk to the switching value such that the acceleration α does not go beyond the upper limit value αH or the lower limit value αL.

According to this configuration, when two positives or negatives coincide and the acceleration α may go beyond the upper limit value αH or the lower limit value αL, whether or not the acceleration α actually goes beyond the upper limit value αH or the lower limit value αL is determined. When determining that the acceleration α actually goes beyond, by setting the initial value j0 of jerk to the switching value such that the acceleration α does not go beyond the upper limit value αH or the lower limit value αL, the acceleration α can be prevented from going beyond the upper limit value αH or lower limit value αL. When determining that the acceleration α does not actually go beyond, the optimum value of the previous calculation cycle is set to the initial value. Accordingly, when two positives or negatives coincide, the determination is performed stepwisely, and the initial value can be set more appropriately.

In the present embodiment, the initial value setting unit 54 uses 0 as the switching value.

According to this configuration, when determining that it goes beyond, since the initial value j0 of jerk is set to 0, the acceleration α does not increase or decrease and is maintained at constant value. Accordingly, the acceleration α can be prevented from going beyond the upper limit value αH or the lower limit value αL.

A value other than 0 may be used as the switching value. The initial value setting unit 54 may set the switching value based on a value according to the upper limit value αH or the lower limit value αL. For example, the initial value setting unit 54 may set, as the switching value, a predetermined value which has a positive or negative opposite to the positive or negative of the upper limit value αH or the lower limit value αL which was gone beyond.

A value that is smaller than the upper limit value αH by a predetermined value may be used as the upper limit value H used for determination. A value that is larger than the lower limit value αL by a predetermined value may be used as the lower limit value αL used for determination. While a margin is given to the acceleration α with respect to the upper limit value αH or the lower limit value αL, the initial value j0 of jerk can be set.

While the time point k is increased one by one from 0 to N, at each time point, the initial value setting unit 54 determines whether or not two positives or negatives coincide with each other. When two positives or negatives do not coincide, the initial value setting unit 54 sets the initial value j0 of jerk at its time point to the optimum value j* of jerk at its time point of the previous calculation cycle. On the other hand, when two positives or negatives do not coincide, using the initial value j0 of jerk already set before its time point and the optimum value j* of jerk at its time point of the previous calculation cycle as the initial value, the initial value setting unit 54 calculates the acceleration α to the next time point in order, and determines whether or not the acceleration α at the next time point goes beyond the upper limit value αH or the lower limit value αL. Then, the initial value setting unit 54 sets the initial value j0 of jerk at its time point to the optimum value j* of jerk at its time point of the previous calculation cycle, when determining that it does not go beyond; and sets the initial value j0 of jerk at its time point to the switching value, when determining that it goes beyond.

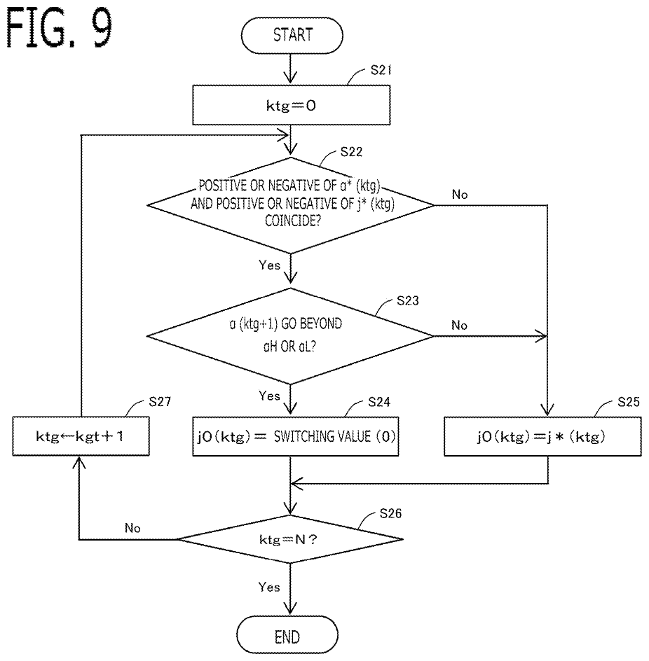

The processing of the initial value setting unit 54 explained above can be configured like the flowchart of FIG. 9. In the step S21, the time point ktg of processing object is set to 0. Then, in the step S22, the initial value setting unit 54 determines whether or not the positive or negative of the optimum value α*(ktg) of acceleration at the time point ktg of processing object calculated in the previous calculation cycle, and the positive or negative of optimum value j*(ktg) of jerk at the time point ktg of processing object calculated in the previous calculation cycle coincide with each other. When two positives or negatives coincide, it advances to the step S23, and when two positives or negatives do not coincide, it advances to the step S25.

In the step S23, using the initial values j0(0) to j0(ktg−1) of jerk already set before the time point ktg of processing object, and the optimum value j*(ktg) of jerk at the time point ktg of processing object of the previous calculation cycle as the initial value j0(ktg) at time point ktg of processing object, and using the equation (12), the initial value setting unit 54 calculates the acceleration α(ktg+1) to the next time point ktg+1 of the processing object in order. Then, the initial value setting unit 54 determines whether the acceleration α(ktg+1) at the next time point of the processing object exceeds the upper limit value αH, or goes below the lower limit value αL. When it exceeds or goes below, it advances to the step S24, and when it does not exceed and does not go below, it advances to the step S25.

In the step S24, the initial value setting unit 54 sets the initial value j0(ktg) of jerk at the time point ktg of processing object, to the switching value (in this example, 0) such that the acceleration α(ktg+1) at the next time point of the processing object does not go beyond the upper limit value αH or the lower limit value αL. On the other hand, in the step S25, the initial value setting unit 54 sets the initial value j0(ktg) of jerk at the time point ktg of processing object, to the optimum value j*(ktg) of jerk at the time point ktg of processing object calculated in the previous calculation cycle.

Then, in the step S26, the initial value setting unit 54 determines whether or not the time point ktg of processing object is the final time point N. When it is not the final time point N, it advances to the step S27, and the time point ktg of processing object is increased by one, then, it returns to the step S22. When it is the final time point N, the processing is ended.

### Setting of Initial Value of Steering Angle Speed

The input variable of the second specific type is set to the steering angle speed ω, and the evaluation element of the second object type relevant to the input variable of the second specific type is set to the third and the fourth constraint conditions g3, g4 which were shown in the equation (11). The third and the fourth constraint conditions g3, g4 (the evaluation elements of the object type) are the evaluation elements for upper-limiting and lower-limiting the position X in the lateral direction (the state variable of the specific influence) which is the state variable changing according to the steering angle speed ω (the input variable of the specific type) by the positive upper limit value XH and the negative lower limit value XL.

Similarly to Embodiment 1, the initial value setting unit 54 determines whether or not a positive or negative of the optimum value ω* of steering angle speed calculated in the previous calculation cycle and a positive or negative of the optimum value X* of position in the lateral direction calculated in the previous calculation cycle coincide with each other.

Similarly to Embodiment 1, when two positives or negatives do not coincide, the initial value setting unit 54 uses the setting method which sets the initial value ω0 of steering angle speed to the optimum value ω* of steering angle speed calculated in the previous calculation cycle.

On the other hand, unlike Embodiment 1, when two positives or negatives coincide, similarly to Embodiment 2, the initial value setting unit 54 determines whether or not the position X in the lateral direction goes beyond the upper limit value XH or the lower limit value XL if the initial value ω0 of steering angle speed is set to the optimum value ω* of steering angle speed calculated in the previous calculation cycle. Then, when determining that the position X in the lateral direction does not go beyond the upper limit value XH or the lower limit value XL, the initial value setting unit 54 uses the setting method which sets the initial value ω0 of steering angle speed to the optimum value ω* of steering angle speed calculated in the previous calculation cycle. On the other hand, when determining that the position X in the lateral direction goes beyond the upper limit value XH or the lower limit value XL, the initial value setting unit 54 uses the setting method which sets the initial value ω0 of steering angle speed to the switching value such that the position X in the lateral direction does not go beyond the upper limit value XH or the lower limit value XL.

According to this configuration, when two positives or negatives coincide and the position X in the lateral direction may go beyond the upper limit value XH or the lower limit value XL, whether or not the position X in the lateral direction actually goes beyond the upper limit value XH or the lower limit value XL is determined. When determining that the position X in the lateral direction actually goes beyond, by setting the initial value ω0 of steering angle speed to the switching value such that the position X in the lateral direction does not go beyond the upper limit value XH or the lower limit value XL, the position X in the lateral direction can be prevented from going beyond the upper limit value XH or the lower limit value XL. When determining that the position X does not actually go beyond, the optimum value of the previous calculation cycle is set to the initial value. Accordingly, when two positives or negatives coincide, the determination is performed stepwisely, and the initial value can be set more appropriately.

In the present embodiment, the initial value setting unit 54 uses 0 as the switching value.

According to this configuration, when determining that it goes beyond, since the initial value ω0 of steering angle speed is set to 0, the position X in the lateral direction does not increase or decrease largely. Accordingly, the position X in the lateral direction can be suppressed from going beyond the upper limit value XH or the lower limit value XL.

A value other than 0 may be used as the switching value. The initial value setting unit 54 may set the switching value based on a value according to the upper limit value XH or the lower limit value XL. For example, the initial value setting unit 54 may set, as the switching value, a predetermined value which has a positive or negative opposite to the positive or negative of the upper limit value XH or the lower limit value XL which was gone beyond.

A value that is smaller than the upper limit value XH by a predetermined value may be used as the upper limit value XH used for determination. A value that is larger than the lower limit value XL by a predetermined value may be used as the lower limit value XL used for determination. While a margin is given to the position X in the lateral direction with respect to the upper limit value XH or the lower limit value XL, the initial value ω0 of steering angle speed can be set.

While the time point k is increased one by one from 0 to N, at each time point, the initial value setting unit 54 determines whether or not two positives or negatives coincide with each other. When two positives or negatives do not coincide, the initial value setting unit 54 sets the initial value ω0 of steering angle speed at its time point to the optimum value ω* of steering angle speed at its time point of the previous calculation cycle. On the other hand, when two positives or negatives do not coincide, using the initial value ω0 of steering angle speed already set before its time point, and the optimum value ω* of steering angle speed at its time point of the previous calculation cycle as the initial value, the initial value setting unit 54 calculates the position X in the lateral direction to the next time point in order.

Then, the initial value setting unit 54 determines whether or not the position X in the lateral direction at the next time point goes beyond the upper limit value XH or the lower limit value XL. Then, the initial value setting unit 54 sets the initial value ω0 of steering angle speed at its time point to the optimum value ω* of steering angle speed at its time point of the previous calculation cycle, when determining that it does not go beyond; and sets the initial value ω0 of steering angle speed at its time point to the switching value, when determining that it goes beyond.

Since the setting processing of the initial value ω0 of steering angle speed is similar to the initial value j0 of jerk shown in the flowchart of FIG. 9, explanation is omitted.

### Example of Conversion

In each of the above-mentioned embodiments, there was explained the case where the vehicle model is used for the state equation, and the optimization problem of vehicle control is solved. However, equations of various control objects may be used for the state equation, and the optimal calculation apparatus may be applied to optimization problems of various control objects.

Even if the vehicle model is used for the state equation, vehicle models different from the equation (8) may be used. For example, a vehicle model for controlling only the acceleration α as the vehicle control amount may be used, a vehicle model for controlling only the steering angle δ as the vehicle control amount may be used, and a vehicle model for controlling other vehicle control amount may be used.

In each of the above-mentioned embodiments, there was explained the case where, as the evaluation elements, the constraint condition of the acceleration α and the constraint condition of the position X in the lateral direction are used. However, as the evaluation element, various types of one or a plurality of constraint conditions may be used. For example, for the constraint condition as the evaluation element, only the constraint condition of the acceleration α may be used, only the constraint condition of the position X in the lateral direction may be used, and the constraint condition of other state variables or input variables may be used.

In each of the above-mentioned embodiments, there was explained the case where Karush-Kuhn-Tucker condition (KTK condition) is used for the optimization problem. However, as the solution of the optimization problem, various solutions may be used. Even in this case, the initial calculation using the initial value can be performed while excluding the constraint condition of the object type from the optimization problem, and the arithmetic processing load can be reduced.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

51: Peripheral State Acquisition Unit, 52: Traveling State Acquisition Unit, 53: Target Traveling State Setting Unit, 54: Initial Value Setting Unit, 55: Optimum Value Calculation Unit, 56: Vehicle Control Unit, J: Evaluation function, X: Position in Lateral Direction, g: Constraint Condition, j: Jerk, u: Input Variable, x: State Variable, α: Acceleration, λ: Lagrange multiplier, ω: Steering Angle Speed

1.-14. (canceled)

15. An optimal calculation apparatus comprising at least one processor configured to implement:
an initial value setter that sets an initial value of an input variable at each time point of a prediction period; and
an optimum value calculator that, every calculation cycle, updates the input variable from the initial value by repeated calculations, so as to solve an optimization problem with two or more evaluation elements, using a state equation which calculates a state variable with the input variable as an input; and calculates optimum values of the state variable and the input variable at each time point of the prediction period,
wherein the initial value setter sets the initial value of the input variable of a specific type by switching a plurality of setting methods so that the evaluation element of an object type relevant to the input variable of the specific type can be excluded from the optimization problem in an initial calculation using the initial value in the optimum value calculator, and
wherein, in the initial calculation using the initial value, the optimum value calculator excludes the evaluation element of the object type relevant to the input variable of the specific type from the optimization problem, and calculates the optimum values.

16. The optimal calculation apparatus according to claim 15,
wherein the evaluation element of the object type is the evaluation element for upper-limiting and lower-limiting the state variable of a specific influence which is the state variable changing according to the input variable of the specific type, by a positive upper limit value and a negative lower limit value, and
wherein the initial value setter determines whether or not a positive or negative of the optimum value of the input variable of the specific type calculated in the previous calculation cycle and a positive or negative of the optimum value of the state variable of the specific influence calculated in the previous calculation cycle coincide with each other; and sets the initial value of the input variable of the specific type by switching the plurality of setting methods according to whether or not two positives or negatives coincide.

17. The optimal calculation apparatus according to claim 16,
wherein, when two positives or negatives do not coincide, the initial value setter uses the setting method which sets the initial value of the input variable of the specific type, to the optimum value of the input variable of the specific type calculated in the previous calculation cycle.

18. The optimal calculation apparatus according to claim 16,
wherein, when two positives or negatives coincide, the initial value setter uses the setting method which sets the initial value of the input variable of the specific type, to a switching value such that the state variable of the specific influence does not go beyond the upper limit value or the lower limit value.

19. The optimal calculation apparatus according to claim 16,
wherein, when two positives or negatives coincide, the initial value setter determines whether or not the state variable of the specific influence goes beyond the upper limit value or the lower limit value if the initial value of the specific type is set to the optimum value of the input variable of the specific type calculated in the previous calculation cycle;
when determining that it does not go beyond, the initial value setter uses the setting method which sets the initial value of the specific type, to the optimum value of the input variable of the specific type calculated in the previous calculation cycle; and
when determining that it goes beyond, the initial value setter uses the setting method which sets the initial value of the specific type, to the switching value such that the state variable of the specific influence does not go beyond the upper limit value or the lower limit value.

20. The optimal calculation apparatus according to claim 15,
wherein the evaluation element of the object type is the evaluation element for upper-limiting and lower-limiting the state variable of a specific influence which is the state variable changing according to an integration of the input variable of the specific type, by a upper limit value and a lower limit value, and
wherein the initial value setter determines whether or not the state variable of the specific influence goes beyond the upper limit value or the lower limit value if the initial value of the specific type is set to the optimum value of the input variable of the specific type calculated in the previous calculation cycle; and sets the initial value of the input variable of the specific type by switching the plurality of setting methods according to whether or not it goes beyond.

21. The optimal calculation apparatus according to claim 20,
wherein, when determining that it does not go beyond, the initial value setter uses the setting method which sets the initial value of the input variable of the specific type, to the optimum value of the input variable of the specific type calculated in the previous calculation cycle.

22. The optimal calculation apparatus according to claim 20,
wherein, when determining that it goes beyond, the initial value setter uses the setting method which sets the initial value of the input variable of the specific type, to a switching value such that the state variable of the specific influence does not go beyond the upper limit value or the lower limit value.

23. The optimal calculation apparatus according to claim 18,
wherein the initial value setter uses 0 as the switching value.

24. The optimal calculation apparatus according to claim 18,
wherein the initial value setter sets the switching value, based on a value according to the upper limit value or the lower limit value.

25. The optimal calculation apparatus according to claim 19,
wherein the initial value setter uses 0 as the switching value.

26. The optimal calculation apparatus according to claim 19,
wherein the initial value setter sets the switching value, based on a value according to the upper limit value or the lower limit value.

27. The optimal calculation apparatus according to claim 22,
wherein the initial value setter uses 0 as the switching value.

28. The optimal calculation apparatus according to claim 22,
wherein the initial value setter sets the switching value, based on a value according to the upper limit value or the lower limit value.

29. The optimal calculation apparatus according to claim 15, further comprising:
a periphery state acquisitor that acquires a periphery state of an ego vehicle;
a traveling state acquisitor that acquires a traveling state of the ego vehicle;
a target traveling state setter that sets a target traveling state of the ego vehicle; and
a vehicle controller that controls the ego vehicle based on a target value of vehicle control amount,
wherein the optimum value calculator, every calculation cycle, updates the input variable from the initial value by repeated calculations, so as to solve the optimization problem with an evaluation function as the evaluation element in which an evaluation becomes high at least as a difference between the target traveling state and a prediction traveling state becomes small, and the evaluation element of the object type relevant to the input variable of the specific type, using the state equation which calculates the state variable expressing a behavior of the ego vehicle with the input variable concerning a vehicle control as the input;
calculates the optimum value of the input variable at each time point of the prediction period; and
sets the target value of vehicle control amount based on the optimum value of the input variable.

30. The optimal calculation apparatus according to claim 29,
wherein the evaluation element of the object type is the evaluation element for limiting the state variable of a specific influence which is the state variable changing according to the input variable of the specific type, by the limit value,
wherein the input variable of the specific type is a jerk of the ego vehicle,
wherein the state variable of the specific influence is an acceleration of the ego vehicle, and
wherein the target value of vehicle control amount is an acceleration of the ego vehicle.

31. The optimal calculation apparatus according to claim 29,
wherein the evaluation element of the object type is the evaluation element for limiting the state variable of a specific influence which is the state variable changing according to the input variable of the specific type, by the limit value,
wherein the input variable of the specific type is a steering angle speed of the ego vehicle,
wherein the state variable of the specific influence is a position in the lateral direction of the ego vehicle, and
wherein the target value of vehicle control amount is a steering angle of the ego vehicle.

32. The optimal calculation apparatus according to claim 15,
wherein the optimization problem has Karush-Kuhn-Tucker condition which is an optimal condition, to be satisfied by the optimum values, which linearly combines gradients of two or more the evaluation elements by Lagrange multipliers.
